(19) United States
(12) Patent Application Publication
(10) Pub. No.: US 2026/0229176 A1
(43) Pub. Date: Aug. 6, 2026

(54) ELECTRONIC DEVICE

(71) Applicant: Samsung Display Co., Ltd., Yongin-Si (KR)

(72) Inventors: KEUNWOO KIM, Yongin-si (KR); HYUNEOK SHIN, Yongin-si (KR)

(21) Appl. No.: 19/365,767

(22) Filed: Oct. 22, 2025

(30) Foreign Application Priority Data
Feb. 3, 2025 (KR) 10-2025-0012979

(51) Int. Cl. G09G 3/3233; G09G 3/3266

(52) U.S. Cl. CPC G09G 3/3233; G09G 3/3266; G09G 2300/0426; G09G 2300/0819; G09G 2300/0852; G09G 2320/0257

(57) ABSTRACT

An electronic device includes a pixel including a pixel circuit and a light emitting element, a data line, a first scan line, a second scan line, a first driving voltage line, a second driving voltage line, and an initialization voltage line. The pixel circuit includes a first capacitor including a first electrode electrically connected to a first node and a second electrode electrically connected to a second node, a first transistor including a first electrode electrically connected to the first driving voltage line, a second electrode electrically connected to the second node, a first gate electrode electrically connected to the first node, and a second gate electrode electrically connected to the second scan line, and a second capacitor including a first electrode electrically connected to the second node and a second electrode electrically connected to the initialization voltage line.

### CROSS-REFERENCE TO RELATED APPLICATION(S

This application claims priority to and the benefit of Korean Patent Application No. 10-2025-0012979, filed on February 3, 2025 in the Korean Intellectual Property Office, the disclosure of which is incorporated by reference herein in its entirety.

### BACKGROUND

### 1. Field

The present disclosure relates to an electronic device with improved display quality.

### 2. Description of Related Art

Multimedia electronic devices, such as televisions, mobile phones, tablet computers, navigation devices, and game devices, include a display device displaying images. The display device includes a display panel and a driver. The driver includes a scan driving circuit that applies scan signals to scan lines and a data driving circuit that applies data voltages to data lines.

### SUMMARY

The present disclosure provides an electronic device with improved display quality.

Embodiments of the inventive concept may provide an electronic device including a pixel including a pixel circuit and a light emitting element electrically connected to the pixel circuit, a data line electrically connected to the pixel and providing a data voltage to the pixel, a first scan line electrically connected to the pixel and providing a first scan signal to the pixel, a second scan line electrically connected to the pixel and providing a second scan signal to the pixel, a first driving voltage line electrically connected to the pixel and providing a first driving voltage to the pixel, a second driving voltage line electrically connected to the pixel and providing a second driving voltage to the pixel, and an initialization voltage line electrically connected to the pixel and providing an initialization voltage to the pixel. The pixel circuit include a first capacitor including a first electrode electrically connected to a first node and a second electrode electrically connected to a second node, a first transistor including a first electrode electrically connected to the first driving voltage line, a second electrode electrically connected to the second node, a first gate electrode electrically connected to the first node, and a second gate electrode electrically connected to the second scan line, and a second capacitor including a first electrode electrically connected to the second node and a second electrode electrically connected to the initialization voltage line.

The second electrode of the first transistor may have a shape formed integrally with the second electrode of the first capacitor and the first electrode of the second capacitor.

The first gate electrode of the first transistor and the first electrode of the first capacitor may be disposed at a same layer.

The second gate electrode of the first transistor and the second electrode of the second capacitor may be disposed at a same layer.

The first capacitor overlaps the second capacitor when viewed in a plane.

The first transistor may be a N-type transistor.

The pixel circuit may further include a second transistor including a first electrode electrically connected to the data line, a second electrode electrically connected to the first gate electrode of the first transistor, and a gate electrode electrically connected to the first scan line.

The first transistor may overlap the second transistor when viewed in the plane.

The electronic device may further include an emission control line electrically connected to the pixel and providing an emission signal to the pixel. The pixel circuit may further include a third transistor including a first electrode electrically connected to the second electrode of the first transistor, a second electrode electrically connected to the light emitting element, and a gate electrode electrically connected to the emission control line.

The first capacitor, the second capacitor, and the third transistor may overlap each other when viewed in the plane.

The pixel may operate in a plurality of frames, and each of the frames includes an initialization period in which the first node is initialized, a compensation period in which a voltage at the first node is compensated for by a threshold voltage of the first transistor, a programming period in which the data voltage is written in the first node through the data line, and a light emission period in which the light emitting element emits a light.

A voltage level of the first driving voltage may vary in each of the frames.

The electronic device further may include an emission control line electrically connected to the pixel and providing an emission signal to the pixel. The pixel circuit may further include a second transistor including a first electrode electrically connected to the data line, a second electrode electrically connected to the first gate electrode of the first transistor, and a gate electrode electrically connected to the first scan line, and a third transistor including a first electrode electrically connected to the second electrode of the first transistor, a second electrode electrically connected to the light emitting element, and a gate electrode electrically connected to the emission control line. In the initialization period, the first driving voltage may have a low voltage level, the first transistor may be turned on, the second transistor may be turned off, and the third transistor may be turned off.

In the compensation period, the first driving voltage may have a high voltage level, the first transistor may be turned on, the second transistor may be turned off, and the third transistor may be turned off.

In the programming period, the first driving voltage may have a high voltage level, the first transistor may be turned off , the third transistor may be turned off, and the second transistor may be turned on, and

The electronic device may further include a third scan line electrically connected to the pixel and providing a third scan signal to the pixel. The pixel circuit may further include a fourth transistor including a first electrode electrically connected to the second node, a second electrode electrically connected to the initialization voltage line, and a gate electrode electrically connected to the third scan line.

The fourth transistor may be an N-type transistor.

The fourth transistor may be a P-type transistor.

Embodiments of the inventive concept may provide an electronic device including a display panel including a pixel including a pixel circuit including a first transistor, a second transistor, a first capacitor, and a second capacitor and a light emitting element electrically connected to the pixel circuit, a data driving circuit outputting a data voltage to the pixel, and a scan driving circuit outputting a plurality of scan signals to the pixel. The first transistor may include a semiconductor layer, a first gate electrode disposed on the semiconductor layer and electrically connected to the second transistor, and a second gate electrode disposed under the semiconductor layer and receiving a scan signal from the scan driving circuit, and the first capacitor and the second capacitor are connected in series between the first gate electrode of the first transistor and an initialization voltage line to which an initialization voltage is applied.

Embodiments of the inventive concept may provide an electronic device including a pixel operating in a plurality of frames and including a pixel circuit and a light emitting element electrically connected to the pixel circuit. The pixel circuit includes a first capacitor connected between a first node and a second node, a first transistor including a first electrode electrically connected to a first driving voltage line receiving a first driving voltage, a second electrode electrically connected to the second node, a first gate electrode electrically connected to the first node, and a second gate electrode electrically connected to a compensation scan line receiving a compensation scan signal, and a second capacitor including a second electrode connected between the second node and an initialization voltage line. Each of the frames may include an initialization period in which the first node is initialized, a compensation period in which a voltage at the first node is compensated for by a threshold voltage of the first transistor, a programming period in which a data voltage is written in the first node through a data line, and a light emission period in which the light emitting element emits a light.

According to the above, a portion of the transistors and a portion of the capacitors of the electronic device may overlap each other when viewed in the plane. Therefore, the area occupied by a single pixel is reduced. As a result, the number of pixels arranged in a display area increases, and the resolution is enhanced. That is, the display quality of the electronic is improved.

In addition, a driving transistor may include an oxide semiconductor layer. Changes in threshold voltage caused by external factors may be reduced in the driving transistor including the oxide semiconductor layer. Accordingly, changes in image quality due to the threshold voltage variations are reduced, and the display quality of the electronic device is improved.

### BRIEF DESCRIPTION OF THE DRAWINGS

FIG. 1 is a block diagram of an electronic device according to an embodiment of the present disclosure.

FIG. 2 is a perspective view of electronic devices according to embodiments of the present disclosure.

FIG. 3 is a cross-sectional view of the electronic device shown in FIG. 1 according to an embodiment of the present disclosure.

FIG. 4 is a cross-sectional view of a display panel shown in FIG. 3 according to an embodiment of the present disclosure.

FIG. 5A is a view of an electronic device according to an embodiment of the present disclosure.

FIG. 5B is an exploded perspective view of the electronic device shown in FIG. 5A according to an embodiment of the present disclosure.

FIG. 6 is a block diagram of an electrode device according to an embodiment of the present disclosure.

FIG. 7 is an equivalent circuit diagram of a pixel according to an embodiment of the present disclosure.

FIG. 8 is a cross-sectional view of a display panel including the pixel shown in FIG. 7 according to an embodiment of the present disclosure.

FIG. 9 is a view illustrating an operating principle of the pixel shown in FIG. 7 according to an embodiment of the present disclosure.

FIG. 10A is a diagram illustrating a driving of a pixel in an initialization period according to an embodiment of the present disclosure.

FIG. 10B is a diagram illustrating a driving of a pixel in a compensation period according to an embodiment of the present disclosure.

FIG. 10C is a diagram illustrating a driving of a pixel in a programming period according to an embodiment of the present disclosure.

FIG. 10D is a diagram illustrating a driving of a pixel in a light emission period according to an embodiment of the present disclosure.

FIG. 11A is an equivalent circuit diagram of a pixel according to an embodiment of the present disclosure.

FIG. 11B is an equivalent circuit diagram of a pixel according to an embodiment of the present disclosure.

### DETAILED DESCRIPTION

In the present disclosure, it will be understood that when an element (or area, layer, or portion) is referred to as being "on", "connected to" or "coupled to" another element or layer, it can be directly on, connected or coupled to the other element or layer or intervening elements or layers may be present.

Like numerals refer to like elements throughout. In the drawings, the thickness, ratio, and dimension of components are exaggerated for effective description of the technical content. As used herein, the term “and/or” may include any and all combinations of one or more of the associated listed items.

It will be understood that, although the terms first, second, etc. may be used herein to describe various elements, these elements should not be limited by these terms. These terms are only used to distinguish one element from another element. Thus, a first element discussed below could be termed a second element without departing from the teachings of the present disclosure. As an example, without departing from the scope of the present disclosure, a first component, a first part, a first region, a first layer, and a first portion are referred to as a second component, a second part, a second region, a second layer, and a second portion, respectively, and vice versa. As used herein, the singular forms, “a”, “an” and “the” are intended to include the plural forms as well, unless the context clearly indicates otherwise.

Spatially relative terms, such as “below”, “lower”, “above”, “upper” and the like, may be used herein for ease of description to describe one element or feature’s relationship to another elements or features as shown in the figures.

It will be further understood that the terms “include” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described with reference to accompanying drawings.

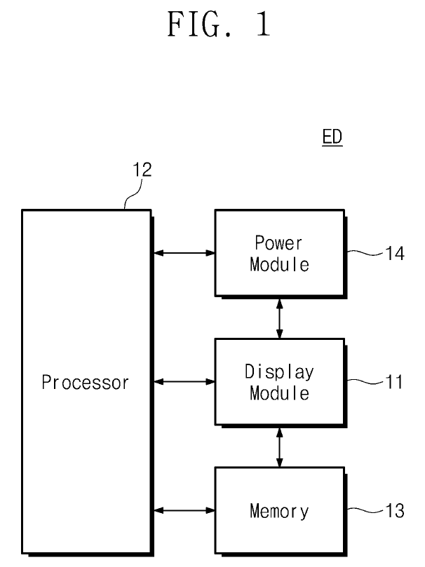

FIG. 1 is a block diagram of an electronic device ED according to an embodiment of the present disclosure.

Referring to FIG. 1, the electronic device ED may include a display module 11, a processor 12, a memory 13, and a power module 14.

The display module 11 may display an image. The image may include a still image as well as a video. The processor 12 may include at least one of a central processing unit (CPU), an application processor (AP), a graphics processing unit (GPU), a communication processor (CP), an image signal processor (ISP), and a controller. The processor 12 may control an operation of the display module 11. The processor 12 may include one or more processors. In implementations with more than one processor, the processors may work individually, collectively or as part of a collective. For example, as part of a collective two out of three processors may operate together to execute instructions for an application.

The memory 13 may store data information for the operation of the processor 12 or the display module 11. When the processor 12 executes an application stored in the memory 13, an image data signal and/or an input control signal may be transmitted to the display module 11, and the display module 11 may process the received signals to output image information through a display screen.

The power module 14 may include a power supply module, such as a power adapter or a battery device, and a power conversion module that converts power supplied by the power supply module to generate power for the operation of the electronic device ED.

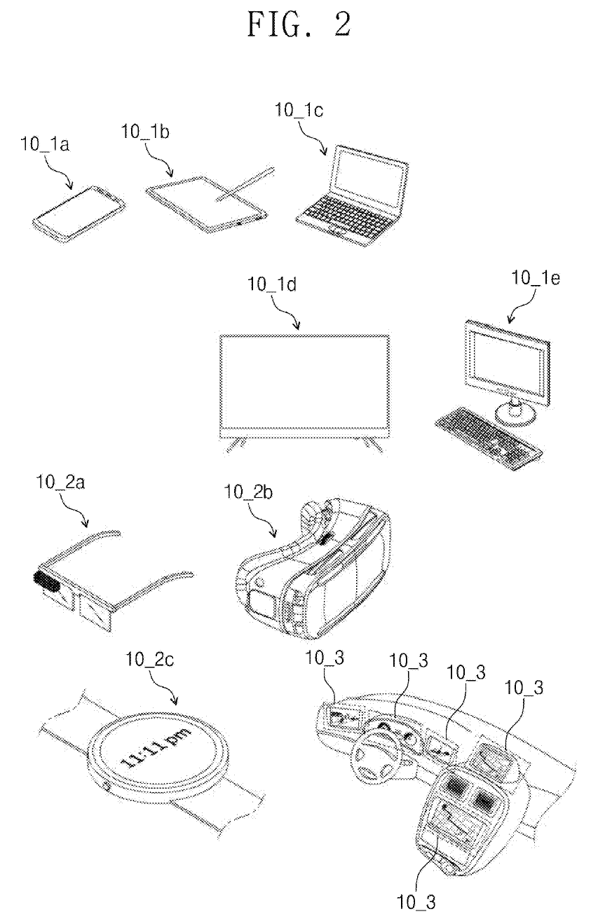

FIG. 2 is a perspective view of electronic devices according to embodiments of the present disclosure.

Referring to FIG. 2, various electronic devices to which a display device according to embodiments is applied may include not only an electronic device for displaying images, such as a smartphone 10_1a, a tablet PC 10_1b, a laptop computer 10_1c, a television 10_1d, a desktop monitor 10_1e, etc., but also a wearable electronic device including a display module, such as a smart glasses 10_2a, a head-mounted display 10_2b, a smartwatch 10_2c, etc., and an in-vehicle electronic device ED_3 including a display module, such as an instrument panel, a center fascia, a dashboard-mounted center information display (CID), a room mirror display, etc.

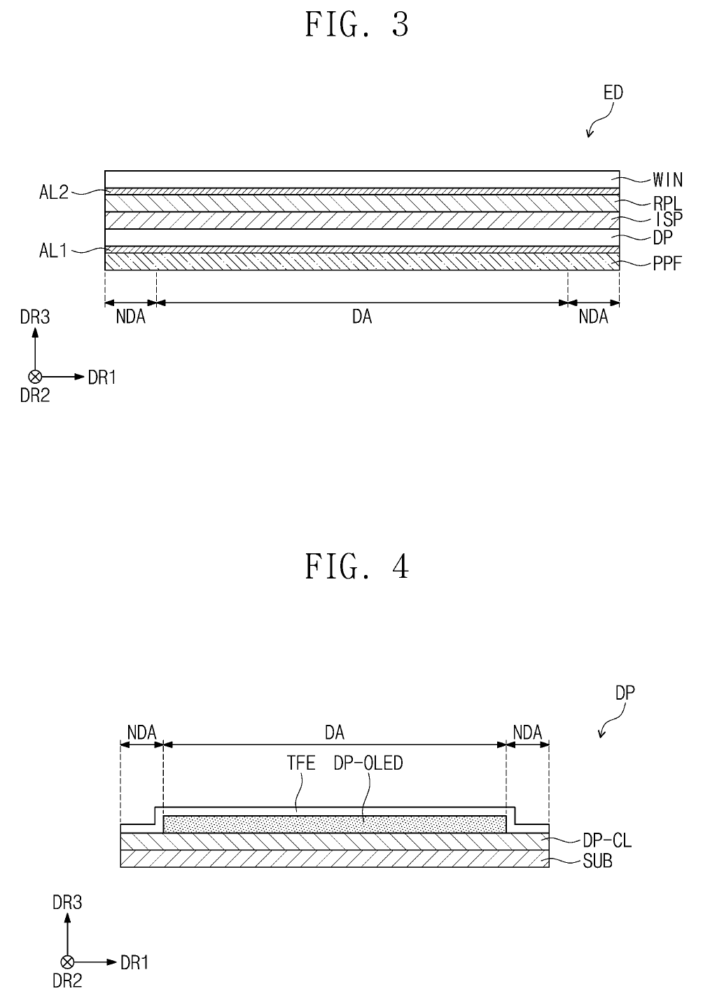

FIG. 3 is a cross-sectional view of the electronic device ED shown in FIG. 1 according to an embodiment of the present disclosure.

As an example, FIG. 3 shows a cross-section of the electronic device ED when viewed from a second direction DR2.

Referring to FIG. 3, the electronic device ED may include a display panel DP, an input sensing part ISP, an anti-reflective layer RPL, a window WIN, a panel protective film PPF, and first and second adhesive layers AL1 and AL2.

The display panel DP may be a flexible display panel. The display panel DP may be a light emitting type display panel. As an example, the display panel DP may be an organic light emitting display panel or an inorganic light emitting display panel. A light emitting layer of the organic light emitting display panel may include an organic light emitting material. A light emitting layer of the inorganic light emitting display panel may include a quantum dot or a quantum rod. Hereinafter, the organic light emitting display panel will be described as a representative example of the display panel DP.

The input sensing part ISP may be disposed on the display panel DP. The input sensing part ISP may include a plurality of sensors (not shown) to sense the external input by a capacitive method. The input sensing part ISP may be directly formed on the display panel DP when the electronic device ED is manufactured, however, it should not be limited thereto or thereby. According to an embodiment, the input sensing part ISP may be attached to the display panel DP by an adhesive layer after being manufactured separately from the display panel DP. According to an embodiment, the input sensing part ISP may be omitted.

The anti-reflective layer RPL may be disposed on the input sensing part ISP. The anti-reflective layer RPL may be formed directly on the input sensing part ISP when the electronic device ED is manufactured, however, the present disclosure should not be limited thereto or thereby. According to an embodiment, the anti-reflective layer RPL may be attached to the input sensing part ISP by an adhesive layer after being manufactured as a separate panel. According to an embodiment, when the input sensing part ISP is omitted, the anti-reflective layer RPL may be directly formed on the display panel DP or may be attached to the display panel DP.

The anti-reflective layer RPL may be defined as an external anti-reflective film. The anti-reflective layer RPL may reduce a reflectance with respect to an external light incident to the display panel DP from the above of the electronic device ED. Due to the anti-reflective layer RPL, the external light may not be perceived by the user.

In a case where the external light traveling toward the display panel DP is reflected by the display panel DP and is provided to the user, like a mirror, the user may perceive the external light. The anti-reflective layer RPL may include the color filters CF that display the same colors as those of the pixels to prevent the above-mentioned phenomenon.

The color filters may filter the external light to have the same color as the pixels. In this case, the external light may not be perceived by the user. However, the present disclosure should not be limited thereto or thereby, and the anti-reflective layer RPL may include a retarder and/or a polarizer to reduce the reflectance of the external light.

The window WIN may be disposed on the anti-reflective layer RPL. The window WIN may protect the display panel DP, the input sensing part ISP, and the anti-reflective layer RPL from external scratches and impacts.

The panel protective film PPF may be disposed under the display panel DP. The panel protective film PPF may protect a lower portion of the display panel DP. The panel protective film PPF may include a flexible plastic material such as polyethylene terephthalate (PET).

The first adhesive layer AL1 may be disposed between the display panel DP and the panel protective film PPF, and the panel protective film PPF may be attached to the display panel DP by the first adhesive layer AL1. The second adhesive layer AL2 may be disposed between the window WIN and the anti-reflective layer RPL, and the window WM may be attached to the anti-reflective layer RPL by the second adhesive layer AL2.

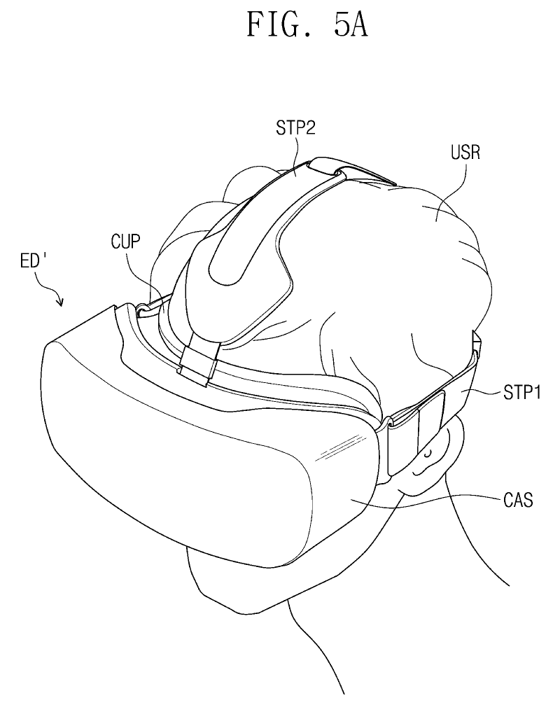

FIG. 4 is a cross-sectional view of the display panel DP shown in FIG. 3 according to an embodiment of the present disclosure.

As an example, FIG. 4 shows a cross-section of the display panel DP when viewed from the second direction DR2.

Referring to FIG. 4, the display panel DP may include a substrate SUB, a circuit element layer DP-CL disposed on the substrate SUB, a display element layer DP-OLED disposed on the circuit element layer DP-CL, and an encapsulation layer TFE disposed on the display element layer DP-OLED.

The substrate SUB may include a display area DA and a non-display area NDA around the display area DA. The substrate SUB may include a glass or a flexible plastic material such as polyimide (PI). The display element layer DP-OLED may be disposed in the display area DA.

A plurality of pixels may be arranged in the circuit element layer DP-CL and the display element layer DP-OLED. Each pixel may include a transistor disposed in the circuit element layer DP-CL and a light emitting element disposed in the display element layer DP-OLED and connected to the transistor.

The thin film encapsulation layer TFE may be disposed on the circuit element layer DP-CL to cover the display element layer DP-OLED. The thin film encapsulation layer TFE may protect the pixels from moisture and oxygen, and a foreign substance such as dust particles.

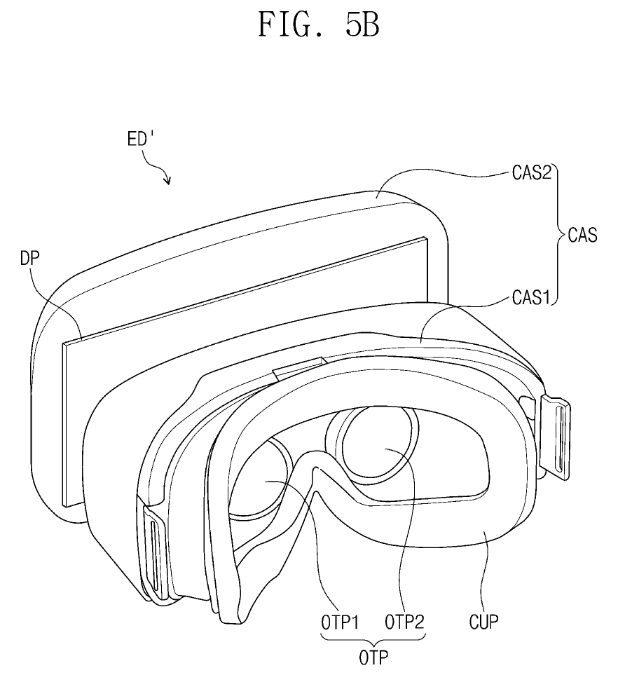

FIG. 5A is a view of an electronic device ED’ according to an embodiment of the present disclosure.

Referring to FIG. 5A, the electronic device ED’ may be activated in response to electrical signals. As an example, the electronic device ED’ may be a mobile phone, a foldable mobile phone, a notebook computer, a television set, a tablet computer, a car navigation unit, a game unit, or a wearable unit, however, it should not be limited thereto or thereby. The wearable unit may be a device that is worn on the body of a user and may include a head-mounted display (HMD) that implements extended reality (XR). FIG. 5A shows the head-mounted display as a representative example of the electronic device ED’, however, the present disclosure should not be limited thereto or thereby. The electronic device ED’ shown in FIG. 5A may correspond to the head-mounted display 10_2b shown in FIG. 2.

The electronic device ED' may block a peripheral vision of the user USR to provide images to the user USR. The electronic device ED' may provide a virtual reality to the user USR. The user USR wearing the electronic device ED' may find it easier to immerse themselves in virtual reality.

The electronic device ED’ may include a case part CAS, a cushion part CUP, and strap parts STP1 and STP2. The case part CAS may be worn by the user USR. The case part CAS may accommodate the display panel DP displaying the images and an acceleration sensor (not shown).

The acceleration sensor may detect the movement of the user USR and may transmit a signal to the display panel DP. Accordingly, the display panel DP may provide the images in response to changes in the line of sight of the user USR. Therefore, the user USR may experience virtual reality that closely resembles real life.

The case part CAS may accommodate components with various functions in addition to the above-described components. For instance, a control part (not shown) may be additionally placed on the exterior of the case part CAS to adjust volume, screen brightness, etc. The control part may be provided as a physical button or a touch sensor. In addition, the case part CAS may accommodate a proximity sensor (not shown) to determine whether the user USR wears the electronic device ED’. The case part CAS may further include an external display panel.

The cushion part CUP may be disposed between the case part CAS and the user USR. The cushion part CUP may be formed of a material that is easily deformed. For instance, the cushion part CUP may include a polymer resin, e.g., polyurethane, polycarbonate, polypropylene, and polyethylene. In addition, the cushion part CUP may include a sponge formed by foam molding rubber latex, a urethane-based material, or an acrylic-based material.

The cushion part CUP may allow the case part CAS to fit securely on the user USR, and thus, the wearing comfort of the user USR may be enhanced. The cushion part CUP may be detachable from the case part CAS.

The strap parts STP1 and STP2 may be coupled to the case part CAS to allow the case part CAS to be easily worn by the user USR. The strap part STR may include a first strap STP1 and a second strap STP2.

The first strap STP1 may be worn around the circumference of the user’s USR head. The first strap STP1 may secure the case part CAS to the user USR so that the case part CAS may fit against the user’s USR head.

The second strap STP2 may connect the case part CAS to the first strap STP1 along an upper portion of the user’s USR head. The second strap STP2 may prevent the case part CAS from slipping down.

FIG. 5B is an exploded perspective view of the electronic device ED’ shown in FIG. 5A according to an embodiment of the present disclosure.

Referring to FIG. 5B, the case part CAS may include a first case CAS1 and a second case CAS2. The first case CAS1 and the second case CAS2 may be separated from each other.

The display panel DP may be disposed between the first case CAS1 and the second case CAS2. The first case CAS1 and the second case CAS2 may be coupled to each other, and the display panel DP may be accommodated in the case part CAS. As an example, the display panel DP may provide a left-eye image and a right-eye image to the user. Accordingly, the display panel DP may provide the user with 3D images.

FIG. 5B shows a structure in which the left-eye image and the right-eye image are provided by a single display panel DP as a representative example, however, the present disclosure should not be limited thereto or thereby. As an example, the left-eye image and the right-eye image may be provided by display panels separated from each other, respectively.

An optical system OTP may be disposed in the first case CAS1. The optical system may magnify the images provided from the display panels DP. The optical system OTP may be placed between the display panels DP and the user’s USR eyes. The optical system OTP may include a left-eye optical system OTP1 and a right-eye optical system OTP2. The left-eye optical system OTP1 may magnify and provide images to a left pupil of the user USR, and the right-eye optical system OTP2 may magnify and provide images to a right pupil of the user USR.

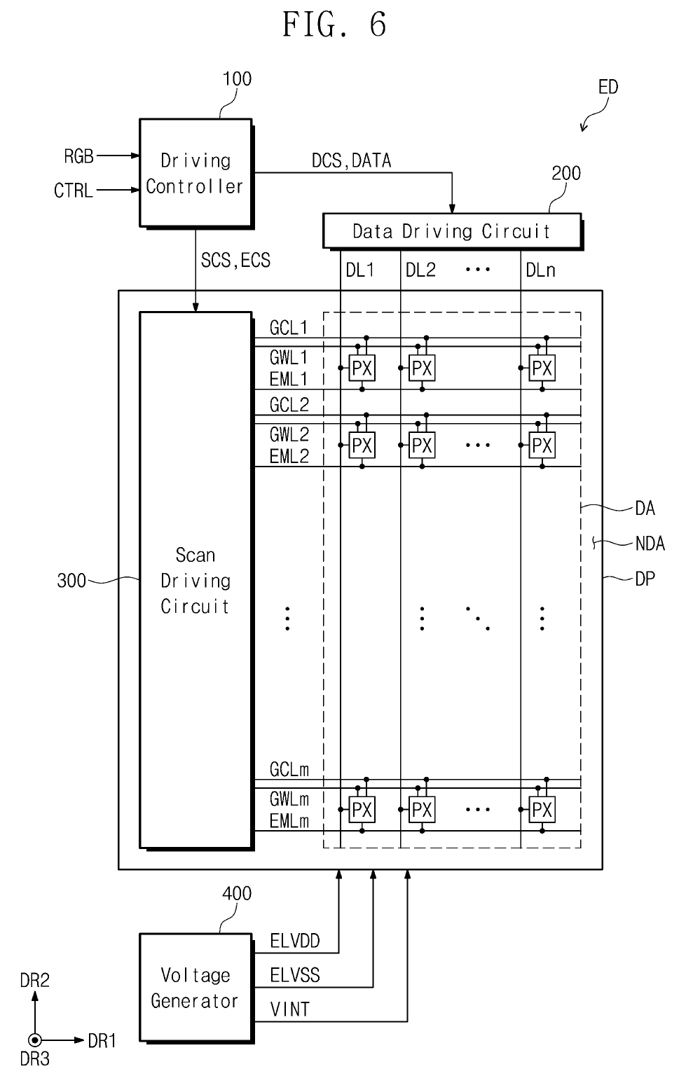

FIG. 6 is a block diagram of the electrode device ED according to an embodiment of the present disclosure.

Referring to FIG. 6, the electronic device ED may include a driving controller 100, a data driving circuit 200, a voltage generator 400, and the display panel DP.

The driving controller 100 may receive an input image signal RGB and a control signal CTRL. The driving controller 100 may convert a data format of the input image signal RGB to a data format appropriate to an interface between the data driving circuit 200 and the driving controller 100 to generate an output image signal DATA. The driving controller 100 may output a data control signal DCS to the data driving circuit 200 and may output a scan control signal SCS to a scan driving circuit 300.

The data driving circuit 200 may receive the data control signal DCS and the output image signal DATA from the driving controller 100. The data driving circuit 200 may convert the output image signal DATA into data signals and may output the data signals to a plurality of data lines DL1 to DLn. Each data signal may have a voltage level corresponding to a grayscale level of the output image signal DATA.

The data driving circuit 200 may be implemented in an integrated circuit (IC) and may be directly mounted on a selected portion of the display panel DP or may be electrically connected to the display panel DP after being mounted on a separate printed circuit board by a chip-on-film (COF) method. According to an embodiment, the driving controller 100 and the data driving circuit 200 may be implemented in separate chips, or the driving controller 100 and the data driving circuit 200 may be implemented in a single chip. According to an embodiment, the data driving circuit 200 may be formed through the same process as a pixel circuit of each of the pixels PX on the display panel DP.

The voltage generator 400 may generate voltages for the operation of the display panel DP. In the present embodiment, the voltage generator 400 may generate a first driving voltage ELVDD, a second driving voltage ELVSS, and an initialization voltage VINT.

The display panel DP may include the display area DA and the non-display area NDA. The display area DA may have a quadrangular shape, however, the present disclosure should not be limited thereto or thereby. The non-display area NDA may have a frame shape surrounding the display area DA.

The display panel DP may further include the scan driving circuit 300. The pixels PX may be arranged in the display area DA, and the scan driving circuit 300 may be arranged in the non-display area NDA, however, the present disclosure should not be limited thereto or thereby. According to an embodiment, at least some of the pixels PX may overlap the scan driving circuit 300. In this case, at least a portion of the scan driving circuit 300 may be disposed in the display area DA.

The display panel DP may include scan lines GWL1 to GWLm and GCL1 to GCLm, the data lines DL1 to DLm, emission control lines EML1 to EMLm, and the pixels PX. Each of “n” and “m” may be an integer number greater than or equal to 2.

The scan driving circuit 300 may receive the scan control signal SCS and an emission control signal ECS from the driving controller 100. The scan driving circuit 300 may output scan signals and emission signals to the scan lines GWL1 to GWLm and GCL1 to GCLm and the emission control lines EML1 to EMLm in response to the scan control signal SCS.

According to an embodiment of the present disclosure, the pixels PX may substantially simultaneously emit lights in response to the emission signals received through the emission control lines EML1 to EMLm. That is, the emission signals may be applied to the pixels PX simultaneously, rather than being sequentially applied by a shift register. Accordingly, since the shift register is omitted, a size of the non-display area NDA may be reduced. In addition, since the pixels PX simultaneously emit the lights, the number of transistors included in each pixel may be reduced, and an area occupied by one pixel PX may decrease. Therefore, the number of the pixels PX arranged in the display area DA may increase, and a resolution of the display panel DP may be improved. That is, the display quality of the electronic device ED may be improved.

The scan driving circuit 300 may be disposed at a first side of the display panel DP. The scan lines GWL1 to GWLm and GCL1 to GCLm and the emission control lines EML1 to EMLm may extend from the scan driving circuit 300 to a first direction DR1. Each of the scan lines GWL1 to GWLm and GCL1 to GCLm and each of the emission control lines EML1 to EMLm may be spaced apart from each other in the second direction DR2. The data lines DL1 to DLn may extend from the data driving circuit 200 to a direction opposite to the second direction DR2 and may be spaced apart from each other in the first direction DR1.

The pixels PX may be arranged in the first direction DR1 and the second direction DR2. Each of the pixels PX may be electrically connected to one data line, two scan lines, and one emission control line. As an example, the pixel PX arranged in a first row and a first column may be electrically connected to a first data line DL1, first scan lines GWL1 and GCL1, and a first emission control line EML1, and the pixel PX arranged in a second row and the first column may be electrically connected to the first data line DL1, second scan lines GWL2 and GCL2, and a second emission control line EML2.

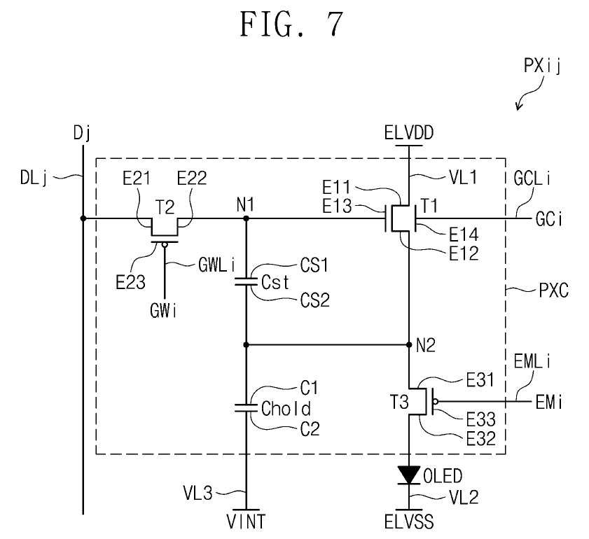

Each of the pixels PX may include a light emitting element OLED (refer to FIG. 7) and a pixel circuit PXC (refer to FIG. 7) controlling the light emission of the light emitting element OLED. The pixel circuit PXC may include one or more thin film transistors and one or more capacitors. The scan driving circuit 300 may include transistors formed through the same process as the pixel circuit PXC.

Each of the pixels PX may receive the first driving voltage ELVDD, the second driving voltage ELVSS, and the initialization voltage VINT from the voltage generator 400.

FIG. 7 is an equivalent circuit diagram of a pixel PXij according to an embodiment of the present disclosure.

Referring to FIGS. 6 and 7, the equivalent circuit diagram of the pixel PXij, which is connected to a j-th data line DLj among the data lines DL1 to DLn, i-th scan lines GWLi and GCLi among the scan lines GWL1 to GWLm and GCL1 to GCLm, and an i-th emission control line EMLi among the emission control lines EML1 to EMLm, is shown. Each of the pixels PX shown in FIG. 6 may have the same circuit configuration as the equivalent circuit diagram of the pixel PXij shown in FIG. 7.

The pixel PXij may include the pixel circuit PXC and the light emitting element OLED electrically connected to the pixel circuit PXC. The pixel circuit PXC may include first, second, and third transistors T1, T2, and T3 and first and second capacitors Cst and Chold. The pixel PXij shown in FIG. 7 is merely an example, and the circuit configuration of the pixel PXij may be modified.

According to an embodiment, the first transistor T1 may be an N-type transistor including an oxide semiconductor layer. The N-type transistor including the oxide semiconductor layer may have a structure that is robust against stress caused by external factors. The stress caused by the above external factors may include stresses caused by voltage, stress caused by temperature, or stress caused by light. This stress may lead to afterimages, such as temporary afterimage or long-term afterimage. A hysteresis of oxide semiconductor may be smaller than a hysteresis of a low-temperature polycrystalline silicon (LTPS). Accordingly, according to the present disclosure, changes in threshold voltage of the first transistor T1, which is the N-type transistor, due to external factors may be reduced. Therefore, changes in image quality due to the changes in threshold voltage may be reduced, and thus, the display quality of the electronic device ED (refer to FIG. 6) may be improved.

Each of the second transistor T2 and the third transistor T3 may be a P-type transistor having a silicon semiconductor layer, however, the present disclosure should not be limited thereto or thereby. According to an embodiment, at least one of the second transistor T2 and the third transistor T3 may be the N-type transistor. The first transistor T1 may be referred to as a driving transistor, the second transistor T2 may be referred to as a write transistor, and the third transistor T3 may be referred to as an emission transistor.

Each of the scan lines GWLi and GCLi may be electrically connected to the pixel PXij. The scan lines GWLi and GCLi may apply scan signals GWi and GCi to the pixel PXij, respectively. Hereinafter, the scan lines GWLi and GCLi may be referred to as a first scan line GWLi and a second scan line GCLi, respectively, and the scan signals GWi and GCi may be referred to as a first scan signal GWi and a second scan signal GCi, respectively. The first scan line GWLi and the second scan line GCLi may also be referred to as a write scan line GWLi and a compensation scan line GCLi, respectively. The first scan signal GWi and the second scan signal GCi may also be referred to as a write scan signal GWi and a compensation scan signal GCi, respectively.

The emission control line EMLi may be electrically connected to the pixel PXij. The emission control line EMLi may apply an emission signal EMi to the pixel PXij.

The data line DLj may be electrically connected to the pixel PXij. The data line DLj may apply a data signal Dj to the pixel PXij. The data signal Dj may have a voltage level corresponding to the input image signal RGB input to the electronic device ED. Accordingly, the data line DLj may apply the data voltage to the pixel PXij.

Each of the first, second, and third driving voltage lines VL1, VL2, and VL3 may be electrically connected to the pixel PXij. The first, second, and third driving voltage lines VL1, VL2, and VL3 may transmit the first driving voltage ELVDD, the second driving voltage ELVSS, and the initialization voltage VINT to the pixel PXij, respectively. Hereinafter, the third driving voltage line VL3 may be referred to as an initialization voltage line VL3.

The first capacitor Cst may include a first electrode CS1 electrically connected to a first node N1 and a second electrode CS2 electrically connected to a second node N2.

The first transistor T1 may include a first electrode E11 electrically connected to the first driving voltage line VL1, a second electrode E12 electrically connected to the second node N2, a first gate electrode E13 electrically connected to the first node N1, and a second gate electrode E14 electrically connected to the second scan line GCLi. The first gate electrode E13 may be referred to as a front gate electrode E13 or a top gate electrode E13, and the second gate electrode E14 may be referred to as a back gate electrode E14 or a bottom gate electrode E14.

The second transistor T2 may include a first electrode E21 electrically connected to the data line DLj, a second electrode E22 electrically connected to the second node N2, and a gate electrode E23 electrically connected to the first scan line GWLi. The second transistor T2 may be turned on or turned off in response to the first scan signal GWi provided through the first scan line GWLi.

The third transistor T3 may include a first electrode E31 electrically connected to the second node N2, a second electrode E32 electrically connected to the light emitting element OLED, and a gate electrode E33 electrically connected to the emission control line EMLi. The third transistor T3 may be turned on or turned off in response to the emission signal EMi provided through the emission control line EMLi.

The second capacitor Chold may include a first electrode C1 electrically connected to the second node N2 and a second electrode C2 electrically connected to the initialization voltage line VL3.

The first capacitor Cst and the second capacitor Chold may be connected in series between the first gate electrode E13 of the first transistor T1 and the initialization voltage line VL3 to which the initialization voltage VINT is applied.

The light emitting element OLED may include an anode electrically connected to the second electrode E32 of the third transistor T3 and a cathode electrically connected to the second driving voltage line VL2. The light emitting element OLED may emit the light based on a driving current provided from the first transistor T1. The light emitting element OLED may be an organic light emitting diode including an organic light emitting layer, however, the present disclosure should not be particularly limited.

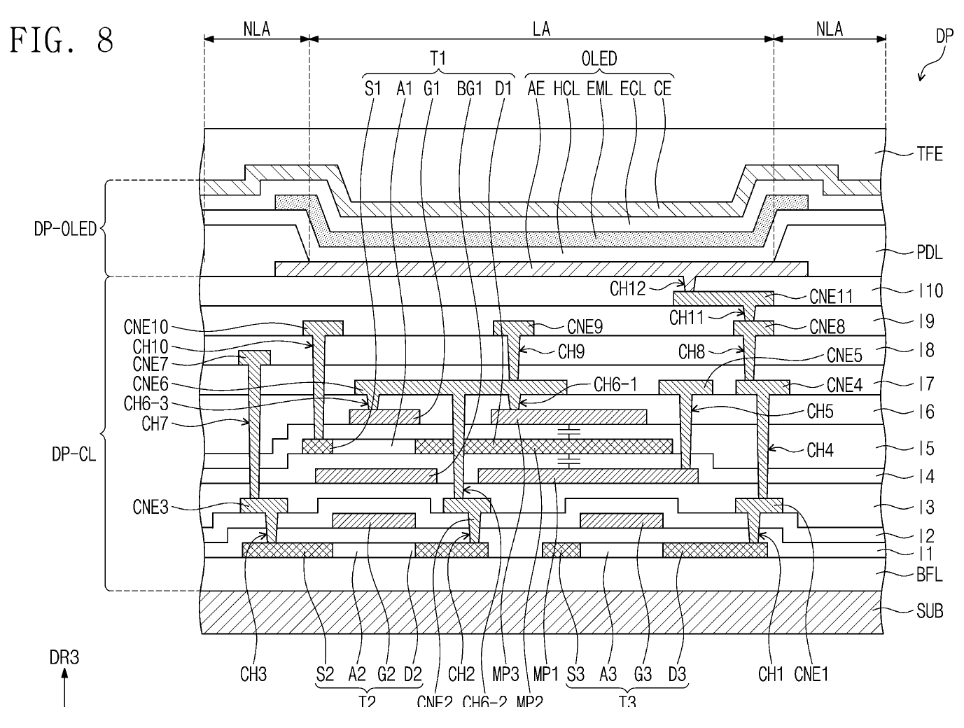

FIG. 8 is a cross-sectional view of the display panel DP including the pixel PXij shown in FIG. 7 according to an embodiment of the present disclosure.

Referring to FIGS. 7 and 8, the display panel DP may include the substrate SUB, the circuit element layer DP-CL, the display element layer DP-OLED, and the thin film encapsulation layer TFE.

At least one inorganic layer may be formed on an upper surface of the substrate SUB. The inorganic layer may include at least one of aluminum oxide, titanium oxide, silicon oxide, silicon nitride, silicon oxynitride, zirconium oxide, and hafnium oxide. The inorganic layer may be formed in multiple layers. The inorganic layers formed in multiple layers may form a barrier layer and/or a buffer layer. In the present embodiment, the circuit element layer DP-CL may include a buffer layer BFL.

The buffer layer BFL may be disposed on the substrate SUB. The buffer layer BFL may increase an adhesion between the substrate SUB and the semiconductor layers. The buffer layer BFL may include at least one of silicon oxide, silicon nitride, and silicon oxynitride. The buffer layer BFL may have a structure in which a silicon oxide layer and a silicon nitride layer are alternately stacked.

According to an embodiment, a second semiconductor layer S2, A2, and D2 of the second transistor T2 and a third semiconductor layer S3, A3, and D3 of the third transistor T3 may be disposed on the buffer layer BFL. Each of the second semiconductor layer S2, A2, and D2 and the third semiconductor layer S3, A3, and D3 may include polycrystalline silicon, however, the present disclosure should not be limited thereto or thereby. According to an embodiment, the second semiconductor layer S2, A2, and D2 and the third semiconductor layer S3, A3, and D3 may include amorphous silicon, low-temperature polycrystalline silicon, or oxide semiconductor.

The second semiconductor layer S2, A2, and D2 may include a second source area S2, a second channel area A2, and a second drain area D2. The second channel area A2 may be disposed between the second source area S2 and the second drain area D2. The second source area S2 may correspond to the first electrode E21 of the second transistor T2. The second drain area D2 may correspond to the second electrode E22 of the second transistor T2. The second source area S2 and the second drain area D2 may have a conductivity through a doping process and may act as a source electrode and a drain electrode of the second transistor T2. The second channel area A2 may substantially correspond to an active of the second transistor T2. The descriptions of the second semiconductor layer S2, A2, and D2, which are provided as a representative example, may be equally applied to the third semiconductor layer S3, A3, and D3.

A first insulating layer I1 may be disposed on the buffer layer BFL. The first insulating layer I1 may commonly overlap the pixels and may cover the second semiconductor layer S2, A2, and D2 and the third semiconductor layer S3, A3, and D3. The first insulating layer I1 may be an inorganic layer and/or an organic layer and may have a single-layer or multi-layer structure. The first insulating layer I1 may include at least one of aluminum oxide, titanium oxide, silicon oxide, silicon nitride, silicon oxynitride, zirconium oxide, and hafnium oxide. In the present embodiment, the first insulating layer I1 may have a single-layer structure of a silicon oxide layer. Not only the first insulating layer I1, but also an insulating layer of the circuit element layer DP-CL described later may commonly overlap the pixels, may be an inorganic layer and/or an organic layer, and may have a single-layer or multi-layer structure. The inorganic layer may include at least one of the above-mentioned materials, however, it should not be limited thereto.

According to an embodiment, a second gate area G2 of the second transistor T2 and a third gate area G3 of the third transistor T3 may be disposed on the first insulating layer I1. That is, the second transistor T2 and the third transistor T3 may be disposed at the same layer.

Although not shown in figures, the second gate area G2 of the second transistor may be electrically connected to the first scan line GWLi, and the third gate area G3 of the third transistor T3 may be electrically connected to the emission control line EMLi.

The second gate area G2 and the third gate area G3 may be a portion of a metal pattern. The second gate area G2 and the third gate area G3 may overlap the second channel area A2 and the third channel area A3, respectively. The second gate area G2 and the third gate area G3 may be used as a mask in a process of doping the second semiconductor layer S2, A2, and D2 and the third semiconductor layer S3, A3, and D3, respectively. The second gate area G2 may correspond to the gate electrode E23 of the second transistor T2, and the third gate area G3 may correspond to the gate electrode E33 of the third transistor T3.

A second insulating layer I2 may be disposed on the first insulating layer I1. The second insulating layer I2 may cover the second gate area G2 and the third gate area G3.

A first connection electrode CNE1, a second connection electrode CNE2, and a third connection electrode CNE3 may be disposed on the second insulating layer I2. The first connection electrode CNE1 may be electrically connected to the third drain area D3 of the third transistor T3 via a first contact hole CH1 defined through the first and second insulating layers I1 and I2. That is, the first connection electrode CNE1 may be electrically connected to the second electrode E32 of the third transistor T3.

The second connection electrode CNE2 may be electrically connected to the second drain area D2 of the second transistor T2 via a second contact hole CH2 defined through the first and second insulating layers I1 and I2. That is, the second connection electrode CNE2 may be electrically connected to the second electrode E22 of the second transistor T2.

The third connection electrode CNE3 may be electrically connected to the second source area S2 of the second transistor T2 via a third contact hole CH3 defined through the first and second insulating layers I1 and I2. That is, the third connection electrode CNE3 may be electrically connected to the first electrode E21 of the second transistor T2.

A third insulating layer I3 may be disposed on the second insulating layer I2. The third insulating layer I3 may cover the first, second, and third connection electrodes CNE1, CNE2, and CNE3.

According to an embodiment, a back gate area BG1 of the first transistor T1 and a first metal pattern MP1 may be disposed on the third insulating layer I3. Although not shown in figures, the back gate area BG1 of the first transistor T1 may be electrically connected to the second scan line GCLi. The back gate area BG1 of the first transistor T1 may correspond to the second gate electrode E14 of the first transistor T1.

A fourth insulating layer I4 may be disposed on the third insulating layer I3. The fourth insulating layer I4 may cover the back gate area BG1 of the first transistor T1 and the first metal pattern MP1.

According to an embodiment, a first semiconductor layer S1, A1, and D1 of the first transistor T1 and a second metal pattern MP2 may be disposed on the fourth insulating layer I4. The first semiconductor layer S1, A1, and D1 may include an oxide semiconductor containing metal oxide. The oxide semiconductor may include crystalline or amorphous oxide semiconductor. The first semiconductor layer S1, A1, and D1 of the first transistor T1 may be referred to as a semiconductor layer S1, A1, and D1.

The first semiconductor layer S1, A1, and D1 may include a first source area S1, a first channel area A1, and a first drain area D1. The first channel area A1 may be disposed between the first source area S1 and the first drain area D1. The first source area S1 may correspond to the first electrode E11 of the first transistor T1. The first drain area D1 may correspond to the second electrode E12 of the first transistor T1. The first source area S1 and the first drain area D1 may have a conductivity through a doping process and may substantially act as a source electrode and a drain electrode of the first transistor T1. The first channel area A1 may substantially correspond to an active of the first transistor T1.

According to an embodiment, the first metal pattern MP1 and the second metal pattern MP2 may form the second capacitor Chold. The first metal pattern MP1 may define the second electrode C2 of the second capacitor Chold, and the second metal pattern MP2 may define the first electrode C1 of the second capacitor Chold.

According to an embodiment, the back gate area BG1 of the first transistor T1 and the second metal pattern MP2 may be disposed at the same layer. That is, the second gate electrode E14 of the first transistor T1 and the second electrode C2 of the second capacitor Chold may be disposed at the same layer.

The first drain area D1 of the first transistor T1 may be formed integrally with the second metal pattern MP2. That is, the second electrode E12 of the first transistor T1 may have an integral shape with the first electrode C1 of the second capacitor Chold.

A fifth insulating layer I5 may be disposed on the fourth insulating layer I4. The fifth insulating layer I5 may cover the first semiconductor layer S1, A1, and D1 of the first transistor T1 and the second metal pattern MP2.

A first gate area G1 of the first transistor T1 and a third metal pattern MP3 may be disposed on the fifth insulating layer I5. The first gate area G1 of the first transistor T1 may correspond to the first gate electrode E13 of the first transistor T1.

According to an embodiment, the first gate area G1 of the first transistor T1 may be disposed on the first semiconductor layer S1, A1, and D1, and the back gate area BG1 of the first transistor T1 may be disposed under the first semiconductor layer S1, A1, and D1.

According to an embodiment, the second metal pattern MP2 may form the first capacitor Cst with the third metal pattern MP3. The second metal pattern MP2 may define the second electrode CS2 of the first capacitor Cst, and the third metal pattern MP3 may define the first electrode CS1 of the first capacitor Cst.

According to an embodiment, the first gate area G1 of the first transistor T1 and the third metal pattern MP3 may be disposed at the same layer. That is, the first gate electrode E13 of the first transistor T1 and the first electrode CS1 of the first capacitor Cst may be disposed at the same layer.

According to an embodiment, the first drain area D1 of the first transistor T1 may be formed integrally with the second metal pattern MP2. That is, the second electrode E12 of the first transistor T1 may have an integral shape with the second electrode CS2 of the first capacitor Cst and the first electrode C1 of the second capacitor Chold.

According to an embodiment, when viewed in a plane, the first transistor T1 may overlap the second transistor T2, and the first capacitor Cst may overlap the second capacitor Chold. In addition, according to an embodiment, the first capacitor Cst, the second capacitor Chold, and the third transistor T3 may overlap each other when viewed in the plane. Accordingly, according to the present disclosure, since the first transistor T1 and the second transistor T2 overlap each other and the first capacitor Cst, the second capacitor Chold, and the third transistor T3 overlap each other, the area occupied by one pixel PXij may be reduced. Therefore, the number of the pixels PX (refer to FIG. 6) arranged in the display area DA (refer to FIG. 6) may increase, and the resolution may be enhanced. That is, the display quality of the electronic device ED (refer to FIG. 6) may be improved.

A sixth insulating layer I6 may be disposed on the fifth insulating layer I5. The sixth insulating layer I6 may cover the first gate area G1 of the first transistor T1 and the third metal pattern MP3.

A fourth connection electrode CNE4, a fifth connection electrode CNE5, and a sixth connection electrode CNE6 may be disposed on the sixth insulating layer I6. The fourth connection electrode CNE4 may be electrically connected to the first connection electrode CNE1 via a fourth contact hole CH4 defined through the third, fourth, fifth, and sixth insulating layers I3, I4, I5, and I6. That is, the fourth connection electrode CNE4 may be electrically connected to the second electrode E32 of the third transistor T3 through the via first connection electrode CNE1.

The fifth connection electrode CNE5 may be electrically connected to the second metal pattern MP2 via a fifth contact hole CH5 defined through the fourth, fifth, and sixth insulating layers I4, I5, and I6. That is, the fifth connection electrode CNE5 may be electrically connected to the second electrode C2 of the second capacitor Chold. Although not shown in figures, the fifth connection electrode CNE5 may be electrically connected to the initialization voltage line VL3. That is, the initialization voltage line VL3 may be electrically connected to the second electrode C2 of the second capacitor Chold through the fifth connection electrode CNE5.

According to an embodiment, the sixth connection electrode CNE6 may be electrically connected to the third metal pattern MP3 via a sixth-first contact hole CH6-1 defined through the sixth insulating layer I6, may be electrically connected to the second connection electrode CNE2 via a sixth-second contact hole CH6-2 defined through the third, fourth, fifth, and sixth insulating layers I3, I4, I5, and I6, and may be electrically connected to the first gate area G1 of the first transistor T1 via a sixth-third contact hole CH6-3 defined through the sixth insulating layer I6. That is, the sixth connection electrode CNE6 may be electrically connected to the first electrode CS1 of the first capacitor Cst, the second electrode E22 of the second transistor T2 through the second connection electrode CNE2, and the first gate electrode E13 of the first transistor T1.

A seventh insulating layer I7 may be disposed on the sixth insulating layer I6. The seventh insulating layer I7 may cover the fourth, fifth, and sixth connection electrodes CNE4, CNE5, and CNE6.

A seventh connection electrode CNE7 may be disposed on the seventh insulating layer I7. The seventh connection electrode CNE7 may be electrically connected to the third connection electrode CNE3 via a seventh contact hole CH7 defined through the third, fourth, fifth, sixth, and seventh insulating layers I3, I4, I5, I6, and I7. That is, the seventh connection electrode CNE7 may be electrically connected to the first electrode E21 of the second transistor T2. Although not shown in figures, the seventh connection electrode CNE7 may be electrically connected to the data line DLj. That is, the data line DLj may be electrically connected to the first electrode E21 of the second transistor T2 through the seventh connection electrode CNE7 and the first connection electrode CNE1.

An eighth insulating layer I8 may be disposed on the seventh insulating layer I7. The eighth insulating layer I8 may cover the seventh connection electrode CNE7.

An eighth connection electrode CNE8, a ninth connection electrode CNE9, and a tenth connection electrode CNE10 may be disposed on the eighth insulating layer I8. The eighth connection electrode CNE8 may be electrically connected to the fourth connection electrode CNE4 via an eighth contact hole CH8 defined through the seventh and eighth insulating layers I7 and I8. That is, the eighth connection electrode CNE8 may be electrically connected to the second electrode E32 of the third transistor T3 through the fourth connection electrode CNE4 and the first connection electrode CNE1.

A ninth connection electrode CNE9 may be electrically connected to the sixth connection electrode CNE6 via a ninth contact hole CH9 defined through the seventh and eighth insulating layers I7 and I8. That is, the ninth connection electrode CNE9 may be electrically connected to the first gate electrode E13 of the first transistor T1, the second electrode E22 of the second transistor T2, and the first electrode CS1 of the first capacitor Cst through the sixth connection electrode CNE6.

A tenth connection electrode CNE10 may be electrically connected to the first source area S1 of the first transistor T1 via a tenth contact hole CH10 defined through the fifth, sixth, seventh, and eighth insulating layers I5, I6, I7, and I8. That is, the tenth connection electrode CNE10 may be electrically connected to the first electrode E11 of the first transistor T1. Although not shown in figures, the tenth connection electrode CNE10 may be electrically connected to the first driving voltage line VL1. That is, the first driving voltage line VL1 may be electrically connected to the first electrode E11 of the first transistor T1 through the tenth connection electrode CNE10.

A ninth insulating layer I9 may be disposed on the eighth insulating layer I8. The ninth insulating layer I9 may cover the eighth, ninth, and tenth connection electrodes CNE8, CNE9, and CNE10.

An eleventh connection electrode CNE11 may be disposed on the ninth insulating layer I9. The eleventh connection electrode CNE11 may be electrically connected to the eighth connection electrode CNE8 via an eleventh contact hole CH11 defined through the ninth insulating layer I9. That is, the eleventh connection electrode CNE11 may be electrically connected to the second electrode E32 of the third transistor T3 through the eighth connection electrode CNE8, the fourth connection electrode CNE4, and the first connection electrode CNE1.

A tenth insulating layer I10 may be disposed on the ninth insulating layer I9. The tenth insulating layer I10 may cover the eleventh connection electrode CNE11.

The light emitting element OLED and a pixel definition layer PDL may be disposed on the tenth insulating layer I10. The display area DA shown in FIG. 6 may include a light emitting area LA corresponding to the pixel PXij and a non-light-emitting area NLA adjacent to the light emitting area LA. The light emitting element OLED may be disposed in the light emitting area LA.

The light emitting element OLED may include a first electrode AE, a hole control layer HCL, a light emitting layer EML, an electron control layer ECL, and a second electrode CE. The first electrode AE of the light emitting element OLED may be the anode, and the second electrode CE of the light emitting element OLED may be the cathode. The second electrode CE of the light emitting element OLED may be disposed on the first electrode AE of the light emitting element OLED, and the hole control layer HCL, the light emitting layer EML, and the electron control layer ECL may be arranged between the first electrode AE of the light emitting element OLED and the second electrode CE of the light emitting element OLED.

The first electrode AE of the light emitting element OLED may be disposed on the tenth insulating layer I10. The first electrode AE of the light emitting element OLED may be electrically connected to the eleventh connection electrode CNE11 via a twelfth contact hole CH12 defined through the tenth insulating layer I10. That is, the first electrode AE of the light emitting element OLED may be electrically connected to the second electrode E32 of the third transistor T3 through the eleventh connection electrode CNE11, the eighth connection electrode CNE8, the fourth connection electrode CNE4, and the first connection electrode CNE1.

The pixel definition layer PDL may be disposed to cover a portion of the first electrode AE of the light emitting element OLED. An opening PX_OP may be defined through the pixel definition layer PDL to expose a portion of the first electrode AE of the light emitting element OLED.

The hole control layer HCL may be disposed on the first electrode AE of the light emitting element OLED and the pixel definition layer PDL. The hole control layer HCL may be commonly disposed in the light emitting area LA and the non-light-emitting area NLA. The hole control layer HCL may include a hole transport layer and a hole injection layer.

The light emitting layer EML may be disposed on the hole control layer HCL. The light emitting layer EML may be disposed in an area corresponding to the opening PX_OP. The light emitting layer EML may include an organic material and/or an inorganic material. The light emitting layer EML may emit a light having one of red, green, and blue colors.

The electron control layer ECL may be disposed on the light emitting layer EML and the hole control layer HCL. The electron control layer ECL may be commonly disposed in the light emitting area LA and the non-light-emitting area NLA. The electron control layer ECL may include an electron transport layer and an electron injection layer.

The second electrode CE of the light emitting element OLED may be disposed on the electron control layer ECL. The second electrode CE of the light emitting element OLED may be commonly disposed in the pixels PX. That is, the second electrode CE of the light emitting element OLED may be commonly disposed on the light emitting layers EML of the pixels PX.

Layers from the buffer layer BFL to the tenth insulating layer I10 may be defined as the circuit element layer DP-CL. Layers on which the light emitting element OLED is disposed may be defined as the display element layer DP-OLED.

The thin film encapsulation layer TFE may be disposed on the light emitting element OLED. The thin film encapsulation layer TFE may include an inorganic layer, an organic layer, and an inorganic layer, which may be stacked in that sequence. The inorganic layers may include an inorganic material and may protect the pixels from moisture and oxygen. The organic layer may include an organic material and may protect the pixels PX (refer to FIG. 6) from a foreign substance, e.g., dust particles.

Holes and electrons injected into the light emitting layer EML may be recombined in the light emitting layer EML to generate excitons, and the light emitting element OLED may emit the light by the excitons that return to a ground state from an excited state. The light emitting element OLED may emit the light to display the images.

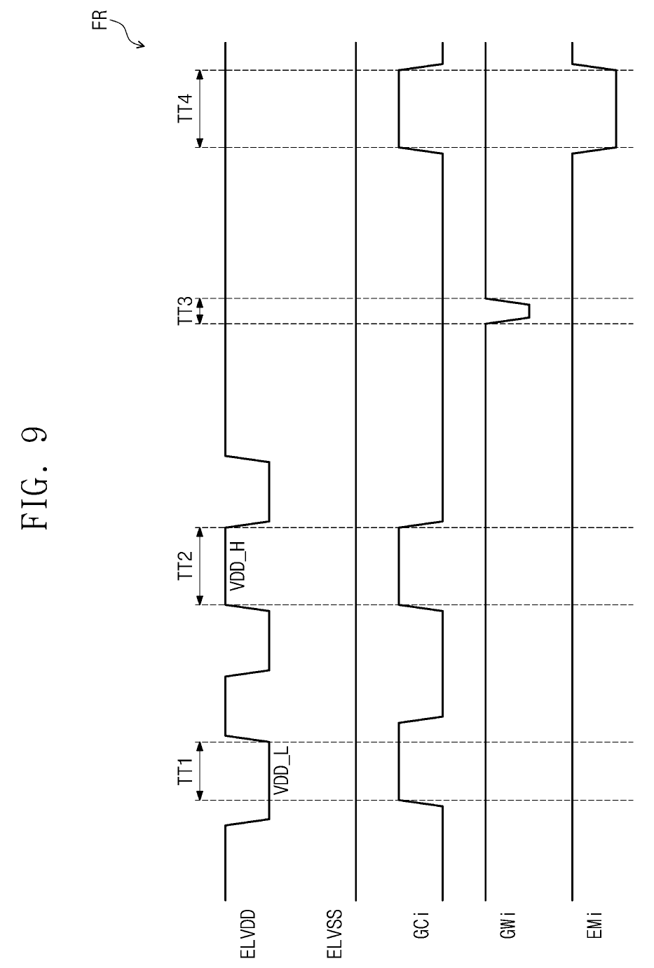

FIG. 9 is a view illustrating an operating principle of the pixel PXij shown in FIG. 7 according to an embodiment of the present disclosure.

Referring to FIGS. 7, 8, and 9, the pixel PXij may be driven in a plurality of frames FR. Each of the frames FR may include an initialization period TT1, a compensation period TT2, a programming period TT3, and a light emission period TT4. FIG. 9 shows waveforms of signals corresponding to one frame FR.

According to an embodiment, a voltage level of the first driving voltage ELVDD may vary during each of the frames. The first driving voltage ELVDD may have a low voltage level VDD_L and a high voltage level VDD_H, which is higher than the low voltage level VDD_L. Each of the second driving voltage ELVSS and the initialization voltage VINT may have a constant voltage whose voltage level does not change. In this case, the voltage level of each of the second driving voltage ELVSS and the initialization voltage VINT may be higher than the low voltage level VDD_L of the first driving voltage ELVDD and lower than the high voltage level VDD_H of the first driving voltage ELVDD.

According to the present embodiment, the low voltage level VDD_L of the first driving voltage ELVDD may be about -6V, the high voltage level VDD_H of the first driving voltage ELVDD may be about 6V, and a constant voltage level of the second driving voltage ELVSS may be about -3V, however, the present disclosure should not be limited thereto or thereby. Different from the waveform of FIG. 9, the voltage level of each of the second driving voltage ELVSS and the initialization voltage VINT may vary.

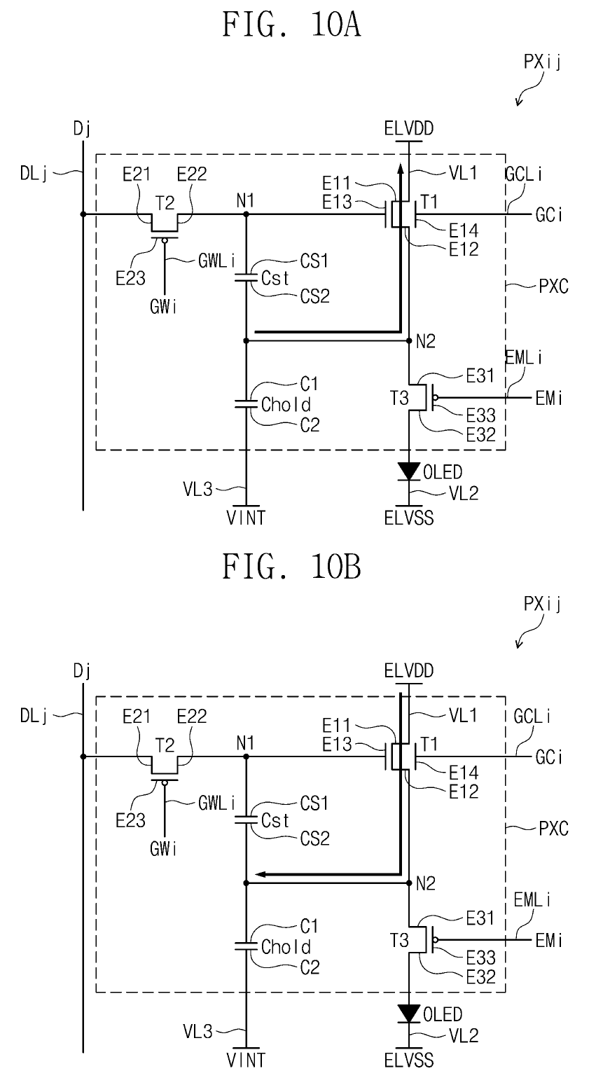

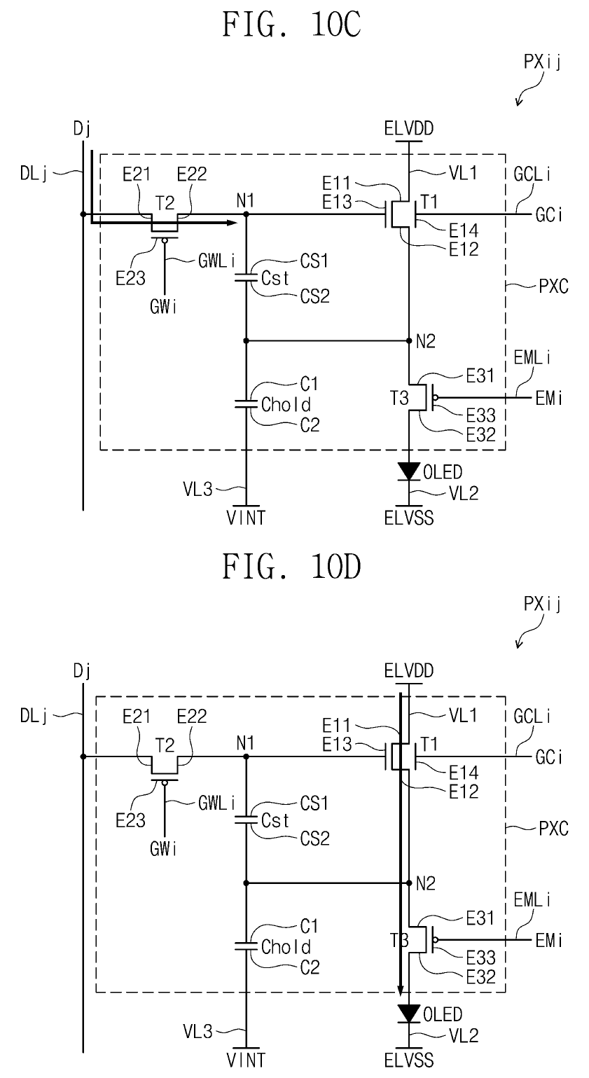

FIG. 10A is a diagram illustrating the driving of the pixel PXij in the initialization period TT1 according to an embodiment of the present disclosure.

Referring to FIGS. 9 and 10A, the initialization period TT1 may be a period in which the low voltage level VDD_L of the first driving voltage ELVDD is applied. In the initialization period TT1, the first scan signal GWi and the emission signal EMi may have an inactive level, for example, a logic high level, and the second scan signal GCi may have an active level, for example, a logic high level.

According to an embodiment, since the second scan signal GCi is applied to the second gate electrode E14 of the first transistor T1, the first transistor T1 may be turned on. Since the first scan signal GWi and the emission signal EMi are respectively applied to the gate electrode E23 of the second transistor T2 and the gate electrode E33 of the third transistor T3, the second transistor T2 and the third transistor T3 may be turned off.

In the initialization period TT1, a current path flowing from the first drain area D1 to the first source area S1 may be formed in the first channel area A1 of the first transistor T1. That is, the current path flowing from the second electrode E12 of the first transistor T1 to the first electrode E11 of the first transistor T1 may be formed. In the initialization period TT1, the first gate electrode E13 of the first transistor T1, i.e., a voltage at the first node N1 and a voltage at the second node N2, may be initialized by the first driving voltage ELVDD having the low voltage level VDD_L.

FIG. 10B is a diagram illustrating the driving of the pixel PXij in the compensation period TT2 according to an embodiment of the present disclosure.

Referring to FIGS. 9 and 10B, the compensation period TT2 may be a period in which the high voltage level VDD_H of the first driving voltage ELVDD is applied. In the compensation period TT2, the first scan signal GWi and the emission signal EMi may have the inactive level, for example, the logic high level, and the second scan signal GCi may have the active level, for example, the logic high level. Accordingly, in the compensation period TT2, a current path flowing from the first source area A1 to the first drain area D1 may be formed in the first channel area A1 of the first transistor T1. That is, the current path flowing from the first electrode E11 of the first transistor T1 to the second electrode E12 of the first transistor T1 may be formed.

According to an embodiment, a threshold voltage of the first transistor T1 may be detected and compensated by a source-follower scheme. According to the source-follower scheme, the voltage at the first node N1 may be compensated for by the threshold voltage of the first transistor T1 by the first capacitor Cst connected between the first gate electrode E13 of the first transistor T1 and the second electrode E12 of the first transistor T1. As an example, the voltage at the first node N1 may be higher than the voltage at the second node N2 by the threshold voltage of the first transistor T1. Accordingly, even when threshold voltage variations occur among the first transistors T1 of the pixels PX (refer to FIG. 6), the threshold voltage variations may be compensated in the compensation period TT2, and thus, the display quality of the images displayed through the display panel DP (refer to FIG. 6) may be improved.

FIG. 10C is a diagram illustrating the driving of the pixel PXij in the programming period TT3 according to an embodiment of the present disclosure.

Referring to FIGS. 9 and 10C, the programming period TT3 may be a period in which the high voltage level VDD_H of the first driving voltage ELVDD is applied. In the programming period TT3, the first scan signal GWi may have the active level, for example, a logic low level, and the second scan signal GCi may have the inactive level, for example, the logic low level, and the emission signal EMi may have the inactive level, for example, a logic high level. Accordingly, the first transistor T1 and the third transistor T3 may be turned off, and the second transistor T2 may be turned on. According to an embodiment, the data voltage may be applied to the first node N1 through the data line DLj in the programming period TT3.

FIG. 10D is a diagram illustrating the driving of the pixel PXij in the light emission period TT4 according to an embodiment of the present disclosure.

Referring to FIGS. 9 and 10D, the light emission period TT4 may be a period in which the high voltage level VDD_H of the first driving voltage ELVDD is applied. In the light emission period TT4, the first scan signal GWi may have the inactive level, for example, the logic high level, the second scan signal GCi may have the active level, for example, the logic high level, and the emission signal EMi may have the active level, for example, the logic low level. Accordingly, the first transistor T1 and the third transistor T3 may be turned on, and the second transistor T2 may be turned off. According to an embodiment, in the light emission period TT4, the light emitting element OLED may receive a driving current corresponding to the data voltage obtained by compensating for the threshold voltage of the first transistor T1 and may emit the light.

According to the present disclosure, the first gate electrode E13 of the first transistor T1 may be used to write the data voltage and to represent and control grayscales through the light emitting element OLED. The second gate electrode E14 of the first transistor T1 may be used to compensate for the threshold voltage of the first transistor T1 and to initialize the first node N1. That is, the first transistor T1 may receive different signals through the first gate electrode E13 and the second gate electrode E14, respectively. The first transistor T1 may have an independent four-terminal structure and may operate as a multi-circuit.

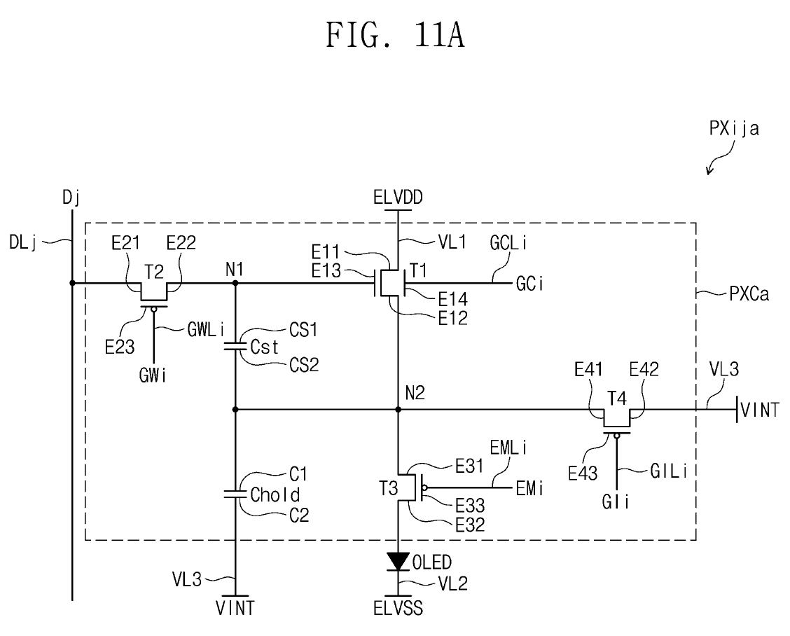

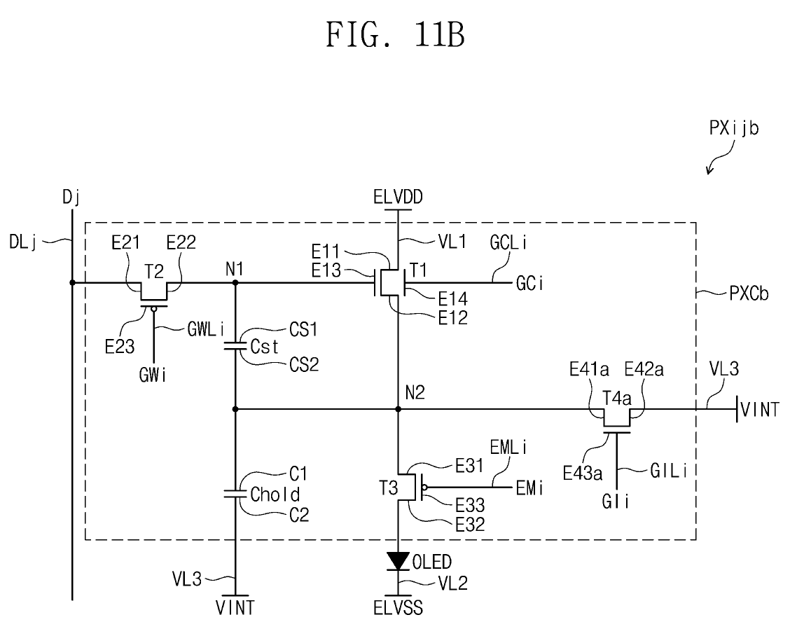

FIG. 11A is an equivalent circuit diagram of a pixel PXija according to an embodiment of the present disclosure. In FIG. 11A, the same reference numerals denote the same elements in FIG. 7, and detailed descriptions of the same elements will be omitted.

Referring to FIGS. 7 and 11A, the display panel DP (refer to FIG. 6) may further include a third scan line GILi electrically connected to the pixel PXija. The third scan line GILi may provide a third scan signal GIi to the pixel PXija. The third scan line GILi may may be referred to as an initialization scan line GILi. The third scan signal GIi may be referred to as an initialization scan signal GIi.

According to an embodiment, a pixel circuit PXCa may further include a fourth transistor T4. The fourth transistor T4 may include a first electrode E41 electrically connected to a second node N2, a second electrode E42 electrically connected to an initialization voltage line VL3, and a gate electrode E43 electrically connected to the third scan line GILi. The fourth transistor T4 may be a P-type transistor including a silicon semiconductor layer.

According to an embodiment, the fourth transistor T4 may receive an initialization voltage VINT through the initialization voltage line VL3. The fourth transistor T4 may apply the initialization voltage VINT received through the initialization voltage line VL3 to the second node N2 in response to the third scan signal GIi provided through the third scan line GILi. Accordingly, since an initialization operation using the fourth transistor T4 is added, the initialization of a first capacitor Cst may be stably performed.

FIG. 11B is an equivalent circuit diagram of a pixel PXijb according to an embodiment of the present disclosure. In FIG. 11B, the same reference numerals denote the same elements in FIG. 7, and detailed descriptions of the same elements will be omitted.

Referring to FIGS. 7 and 11B, the display panel DP (refer to FIG. 6) may further include a third scan line GILi electrically connected to the pixel PXijb. The third scan line GILi may apply a third scan signal GIi to the pixel PXijb. The third scan line GILi may may be referred to as an initialization scan line GILi. The third scan signal GIi may be referred to as an initialization scan signal GIi.

According to an embodiment, a pixel circuit PXCb may further include a fourth transistor T4a. The fourth transistor T4a may include a first electrode E41a electrically connected to a second node N2, a second electrode E42a electrically connected to an initialization voltage line VL3, and a gate electrode E43a electrically connected to the third scan line GILi. The fourth transistor T4a may be an N-type transistor including an oxide semiconductor layer.

According to an embodiment, the fourth transistor T4a may receive an initialization voltage VINT through the initialization voltage line VL3. The fourth transistor T4a may apply the initialization voltage VINT received through the initialization voltage line VL3 to the second node N2 in response to the third scan signal GIi provided through the third scan line GILi. Accordingly, since an initialization operation using the fourth transistor T4a is added, the initialization of a first capacitor Cst may be stably performed.

Although the embodiments of the present disclosure have been described, it is understood that the present disclosure should not be limited to these embodiments, but various changes and modifications can be made by one ordinary skilled in the art within the spirit and scope of the present disclosure as hereinafter claimed.

Therefore, the disclosed subject matter should not be limited to any single embodiment described herein, and the scope of the present inventive concept shall be determined according to the attached claims.

What is claimed is:

1. An electronic device comprising:
a pixel including a pixel circuit and a light emitting element electrically connected to the pixel circuit;
a data line electrically connected to the pixel and providing a data voltage to the pixel;
a first scan line electrically connected to the pixel and providing a first scan signal to the pixel;
a second scan line electrically connected to the pixel and providing a second scan signal to the pixel;
a first driving voltage line electrically connected to the pixel and providing a first driving voltage to the pixel;
a second driving voltage line electrically connected to the pixel and providing a second driving voltage to the pixel; and
an initialization voltage line electrically connected to the pixel and providing an initialization voltage to the pixel, the pixel circuit comprising:
a first capacitor including a first electrode electrically connected to a first node and a second electrode electrically connected to a second node;
a first transistor including a first electrode electrically connected to the first driving voltage line, a second electrode electrically connected to the second node, a first gate electrode electrically connected to the first node, and a second gate electrode electrically connected to the second scan line; and
a second capacitor including a first electrode electrically connected to the second node and a second electrode electrically connected to the initialization voltage line.

2. The electronic device of claim 1, wherein the second electrode of the first transistor has a shape formed integrally with the second electrode of the first capacitor and the first electrode of the second capacitor.

3. The electronic device of claim 1, wherein the first gate electrode of the first transistor and the first electrode of the first capacitor are disposed at a same layer.

4. The electronic device of claim 1, wherein the second gate electrode of the first transistor and the second electrode of the second capacitor are disposed at a same layer.

5. The electronic device of claim 1, wherein the first capacitor overlaps the second capacitor when viewed in a plane.

6. The electronic device of claim 1, wherein the first transistor is an N-type transistor.

7. The electronic device of claim 1, wherein the pixel circuit further comprises a second transistor including a first electrode electrically connected to the data line, a second electrode electrically connected to the first gate electrode of the first transistor, and a gate electrode electrically connected to the first scan line.

8. The electronic device of claim 7, wherein the first transistor overlaps the second transistor when viewed in a plane.

9. The electronic device of claim 7, further comprising an emission control line electrically connected to the pixel and providing an emission signal to the pixel, wherein the pixel circuit further comprises a third transistor comprising a first electrode electrically connected to the second electrode of the first transistor, a second electrode electrically connected to the light emitting element, and a gate electrode electrically connected to the emission control line.

10. The electronic device of claim 9, wherein the first capacitor, the second capacitor, and the third transistor overlap each other when viewed in a plane.

11. The electronic device of claim 1, wherein the pixel operates in a plurality of frames, and each of the frames comprises:
an initialization period in which the first node is initialized;
a compensation period in which a voltage at the first node is compensated for by a threshold voltage of the first transistor;
a programming period in which the data voltage is written in the first node through the data line; and
a light emission period in which the light emitting element emits a light.

12. The electronic device of claim 11, wherein a voltage level of the first driving voltage varies during each of the frames.

13. The electronic device of claim 11, further comprising an emission control line electrically connected to the pixel and providing an emission signal to the pixel, wherein the pixel circuit further comprises:
a second transistor comprising a first electrode electrically connected to the data line, a second electrode electrically connected to the first gate electrode of the first transistor, and a gate electrode electrically connected to the first scan line; and
a third transistor comprising a first electrode electrically connected to the second electrode of the first transistor, a second electrode electrically connected to the light emitting element, and a gate electrode electrically connected to the emission control line, and in the initialization period, the first driving voltage has a low voltage level, the first transistor is turned on, the second transistor is turned off, and the third transistor is turned off.

14. The electronic device of claim 13, wherein, in the compensation period, the first driving voltage has a high voltage level, the first transistor is turned on, the second transistor is turned off, and the third transistor is turned off.

15. The electronic device of claim 13, wherein, in the programming period, the first driving voltage has a high voltage level, the first transistor is turned off, the third transistor is turned off, and the second transistor is turned on, and
in the light emission period, the first driving voltage has the high voltage level, the first transistor is turned on, the third transistor is turned on, and the second transistor is turned off.

16. The electronic device of claim 9, further comprising a third scan line electrically connected to the pixel and providing a third scan signal to the pixel, wherein the pixel circuit further comprises a fourth transistor comprising a first electrode electrically connected to the second node, a second electrode electrically connected to the initialization voltage line, and a gate electrode electrically connected to the third scan line.

17. The electronic device of claim 16, wherein the fourth transistor is an N-type transistor.

18. The electronic device of claim 16, wherein the fourth transistor is a P-type transistor.

19. An electronic device comprising:
a display panel including a pixel, wherein the pixel includes a pixel circuit and a light emitting element electrically connected to the pixel circuit, wherein the pixel circuit includes a first transistor, a second transistor, a first capacitor, and a second capacitor;
a data driving circuit outputting a data voltage to the pixel; and
a scan driving circuit outputting a plurality of scan signals to the pixel, wherein the first transistor includes a semiconductor layer, a first gate electrode disposed on the semiconductor layer and electrically connected to the second transistor, and a second gate electrode disposed under the semiconductor layer and receiving a scan signal from the scan driving circuit, and the first capacitor and the second capacitor are connected in series between the first gate electrode of the first transistor and an initialization voltage line to which an initialization voltage is applied.

20. An electronic device comprising:
a pixel operating in a plurality of frames and the pixel including a pixel circuit and a light emitting element electrically connected to the pixel circuit, the pixel circuit comprising:
a first capacitor connected between a first node and a second node;
a first transistor including a first electrode electrically connected to a first driving voltage line receiving a first driving voltage, a second electrode electrically connected to the second node, a first gate electrode electrically connected to the first node, and a second gate electrode electrically connected to a compensation scan line receiving a compensation scan signal; and
a second capacitor including a second electrode connected between the second node and an initialization voltage line, each of the frames comprising:
an initialization period in which the first node is initialized;
a compensation period in which a voltage at the first node is compensated for by a threshold voltage of the first transistor;
a programming period in which a data voltage is written in the first node through a data line; and
a light emission period in which the light emitting element emits a light.
